(19) United States
(12) Patent Application Publication
(10) Pub. No.: US 2018/0139576 A1
(43) Pub. Date: May 17, 2018

(54) WIRELESS DEVICE, SERVER, INDEX DATA PROVIDING METHOD FOR WIRELESS DEVICE, DATA PROVIDING METHOD FOR SERVER AND WIRELESS TRANSMISSION SYSTEM

(71) Applicant: Institute For Information Industry, Taipei (TW)

(72) Inventors: Liang-Chun CHANG, Taipei City (TW); Yeh-Kuang WU, New Taipei City (TW); Tai-Hung CHEN, New Taipei City (TW)

(21) Appl. No.: 15/369,386

(22) Filed: Dec. 5, 2016

(30) Foreign Application Priority Data
Nov. 16, 2016 (TW) 105137451

(51) Int. Cl. H04W 4/02; H04W 4/00; H04W 8/24; H04W 4/06

(52) U.S. Cl. CPC H04W 4/023; H04W 4/06; H04W 8/24; H04W 4/008

(57) ABSTRACT

A wireless device, a server, an index data providing method for the wireless device, a data providing method for the server and a wireless transmission system are provided. The wireless device includes a transmitter, a storage and a processor. The storage stores a plurality of terminal data, each of the terminal data includes an identification. The processor generates a Bluetooth broadcast signal according to each of the terminal data, and transmits each of the Bluetooth broadcast signals within a plurality of time intervals respectively. After a user equipment receives a current Bluetooth broadcast signal of the Bluetooth broadcast signals, the user equipment transmits a service request message according to the current Bluetooth broadcast signal, and receives a service data from the server. The service data is one of a plurality of service data stored in the server, which corresponds to the current Bluetooth broadcast signal.

### PRIORITY

This application claims priority to Taiwan Patent Application No. 105137451 filed on Nov. 16, 2016, which is hereby incorporated by reference in its entirety.

### FIELD

The present invention relates to a wireless device, a server, an index data providing method for the wireless device, a data providing method for the server and a wireless transmission system. Specifically, the wireless device of the present invention transmits a plurality of Bluetooth broadcast signals within a plurality of time intervals respectively. After receiving a current Bluetooth broadcast signal among the Bluetooth broadcast signals. As a result, a user equipment (UE) can transmit a service request message to a server when it receives a current Bluetooth broadcast signal among the Bluetooth broadcast signals so as to receive a service data, which corresponds to the current Bluetooth broadcast signal and is one of a plurality of service data stored in the server, from the server.

### BACKGROUND

Owing to rapid development of wireless communication technologies, many wireless communication devices (e.g., smartphones and tablet computers) are provided with Global Positioning System (GPS) positioning services. However, the GPS positioning services are only used for outdoor positioning and navigation. In order to provide positioning and navigation services for the wireless communication devices in indoor environments, low power-consumption Bluetooth technologies (e.g., iBeacon, Eddystone, AltBeacon and THLight USBeacon) have been proposed by some incorporations to provide positioning, navigation and even pushing notification for the wireless communication devices in indoor environments.

Currently the indoor positioning technology that is the most widely used is the iBeacon technology proposed by Apple Inc. According to the iBeacon technology, a plurality of iBeacon transmission devices are deployed in an indoor environment and iBeacon signals are periodically transmitted by each of the iBeacon transmission devices. Because the iBeacon signals transmitted by each iBeacon transmission device carry respective identification (ID) information of the iBeacon transmission device, the iBeacon signals may be used as index information of positions. In detail, when a user comes close to an iBeacon transmission device, a UE (e.g., a mobile device) of the user, which receives an iBeacon signal transmitted by the iBeacon transmission device, can generate a request message carrying ID information of the iBeacon signal and then transmit the request message to a server. Afterwards, the server can perform a position matching procedure according to the ID information of the iBeacon signal in the request message transmitted by the UE to obtain position information of the iBeacon signal and provide the position information to the UE.

As an extended application, the position information of the iBeacon signal may be used to provide other services. For example, after obtaining the position information of the iBeacon signal from the UE, the server should determine what service the position corresponds to first based on the position information so that it can learn the corresponding service data and provide them for the UE. In another example where the iBeacon technology is applied to a digital signage, when the UE receives an iBeacon signal transmitted by the digital signage or a nearby iBeacon transmission device and transmits a service request message carrying ID information retrieved from the iBeacon signal to the server, the server should determine position information corresponding to the ID information first, and then determine the digital signage in this position. Next, the server can determine what information is displayed by the digital signage at this time point according to the time when the service request message is received or the time when the iBeacon signal is received by the UE. Finally, based on the time information. the server can obtain the service data corresponding to the displayed information and provide the service data to the UE.

As can be known from the above description that, when the iBeacon technology is applied to other services (especially services featuring high mobility, high customizability and real-time property), a plurality of complex procedures must be done before the server can obtain the corresponding service data. Further, possible asynchronization in time between the UE and the iBeacon device may make it impossible for the server to correctly determine the service data needed by the user or cause that the service data received by the user is not exactly what originally desired by the user.

Accordingly, an urgent need exists in the art to create a real-time data providing mechanism based on Bluetooth broadcast signals conforming to the low power-consumption Bluetooth technologies to simplify the procedure that must be performed by the server so that the server can provide service data needed by the user immediately and the user can surely obtain the needed service data.

### SUMMARY

The disclosure includes a data providing mechanism. In such data providing mechanism, time-variable Bluetooth broadcast signals can carry index data corresponding to different service data are broadcasted so that a UE can provide the index datum carried in the received Bluetooth broadcast signal to a server and the server can directly provide a corresponding service data according to the index datum. Thereby, the data providing mechanism of the present invention can simplify the procedure that needs to be performed by the server so that the service data needed by the user can be immediately provided by the server and the user can surely obtain the needed service data.

The disclosure includes a wireless device, which comprises a transmitter, a storage and a processor. The storage is configured to store a plurality of terminal data. Each of the terminal data includes an identification (ID). The processor is electrically connected to the storage and the transmitter, and is configured to generate a Bluetooth broadcast signal according to the ID of each of the terminal data, and transmit the Bluetooth broadcast signals via the transmitter within a plurality of time intervals respectively. Therefore, a user equipment (UE) receiving a current Bluetooth broadcast signal among the Bluetooth broadcast signals transmits a service request message to a server according to the current Bluetooth broadcast signal and receives a service data, which corresponds to the current Bluetooth broadcast signal and is one of a plurality of service data stored in the server, from the server. The plurality of service data correspond to the terminal data in one-to-one correspondence.

The disclosure also includes a server, which comprises a storage, a network interface and a processor. The storage is configured to store a plurality of service data and a plurality of terminal data, the service data corresponds to the terminal data in one-to-one correspondence, and each of the terminal data includes an ID. The processor is electrically connected to the storage and the network interface, and is configured to receive a service request message from a UE via the network interface and transmit one of the service data to the UE via the network interface according to the service request message. The UE receives a current Bluetooth broadcast signal among a plurality of Bluetooth broadcast signals transmitted by a wireless device within a plurality of time intervals respectively and generates the service request message according to the current Bluetooth broadcast signal, and the wireless device stores the terminal data and generates the corresponding Bluetooth broadcast signal according to the ID of each of the terminal data.

The disclosure further includes an index data providing method for a wireless device. The wireless device comprises a transmitter, a storage and a processor, the storage stores a plurality of terminal data, and each of the terminal data includes an ID. The index data providing method is executed by the processor and comprises the following steps of: generating a Bluetooth broadcast signal according to the ID of each of the terminal data; and transmitting the Bluetooth broadcast signals via the transmitter within a plurality of time intervals respectively. A UE receiving a current Bluetooth broadcast signal among the Bluetooth broadcast signals transmits a service request message to a server according to the current Bluetooth broadcast signal and receives a service data, which corresponds to the current Bluetooth broadcast signal and is one of a plurality of service data stored in the server, from the server. The plurality of service data correspond to the terminal data in one-to-one correspondence.

The disclosure additionally includes a data providing method for a server. The server comprises a storage, a network interface and a processor. The storage stores a plurality of service data and a plurality of terminal data. The service data corresponds to the terminal data in one-to-one correspondence, and each of the terminal data includes an ID. The processor is electrically connected to the storage and the network interface. The data providing method is executed by the processor and comprises the following steps of: receiving a service request message from a UE via the network interface; and transmitting one of the service data to the UE via the network interface according to the service request message. The UE receives a current Bluetooth broadcast signal among a plurality of Bluetooth broadcast signals transmitted by a wireless device within a plurality of time intervals respectively and generates the service request message according to the current Bluetooth broadcast signal, and the wireless device stores the terminal data and generates the corresponding Bluetooth broadcast signal according to the ID of each of the terminal data.

The disclosure also includes a wireless transmission system. The wireless transmission system comprises a Bluetooth device and a management device. The Bluetooth device stores a Bluetooth datum. The management device stores a plurality of terminal data. Each of the terminal data includes an ID. The management device generates a control signal according to the ID of each of the terminal data and transmits the control signals to the Bluetooth device at a plurality of time points respectively. After receiving the control signal transmitted by the management device at each of the time points, the Bluetooth device modifies the Bluetooth datum, generates a Bluetooth broadcast signal based on the Bluetooth datum within a plurality of time intervals of the time points respectively and transmits the Bluetooth broadcast signal. A UE receiving a current Bluetooth broadcast signal among the Bluetooth broadcast signals transmits a service request message to a server according to the current Bluetooth broadcast signal and receives a service data, which corresponds to the current Bluetooth broadcast signal and is one of a plurality of service data stored in the server, from the server. The plurality of service data correspond to the terminal data in one-to-one correspondence.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 depicts an implementation scenario of a wireless device 1, a server 2 and a UE 3 according to the present invention;

FIG. 2 is a schematic view of the wireless device 1 according to the present invention;

FIG. 3 is a schematic view of the server 2 according to the present invention;

FIG. 4 is another schematic view of the wireless device 1 according to the present invention;

FIG. 5 depicts another implementation scenario of the wireless device 1, the server 2 and the UE 3 according to the present invention;

FIG. 6 is another schematic view of the wireless device 1 according to the present invention;

FIG. 7A depicts contents defined in scheduling information 206;

FIG. 7B depicts a correspondence relationship between terminal data 204 and service data 202;

FIG. 7C depicts a correspondence relationship between the service data 202, the terminal data 204 and preloaded data 208;

FIG. 8 depicts another implementation scenario of the wireless device 1, the server 2 and the UE 3 according to the present invention;

FIG. 9 is a schematic view of a wireless transmission system 5 according to the present invention;

FIG. 10 is a flowchart diagram of an index data providing method according to the present invention; and

FIG. 11 is a flowchart diagram of a data providing method according to the present invention.

### DETAILED DESCRIPTION

In the following description, the present invention will be explained with reference to certain example embodiments thereof. It shall be appreciated that, these example embodiments are not intended to limit the present invention to any particular embodiment, example, environment, applications or implementations described in these example embodiments. Therefore, description of these example embodiments is only for purpose of illustration rather than to limit the present invention, and the scope claimed in this application shall be governed by the claims.

In the following embodiments and the attached drawings, elements unrelated to the present invention are omitted from depiction; and dimensional relationships among individual elements in the attached drawings are illustrated only for ease of understanding, but not to limit the actual scale.

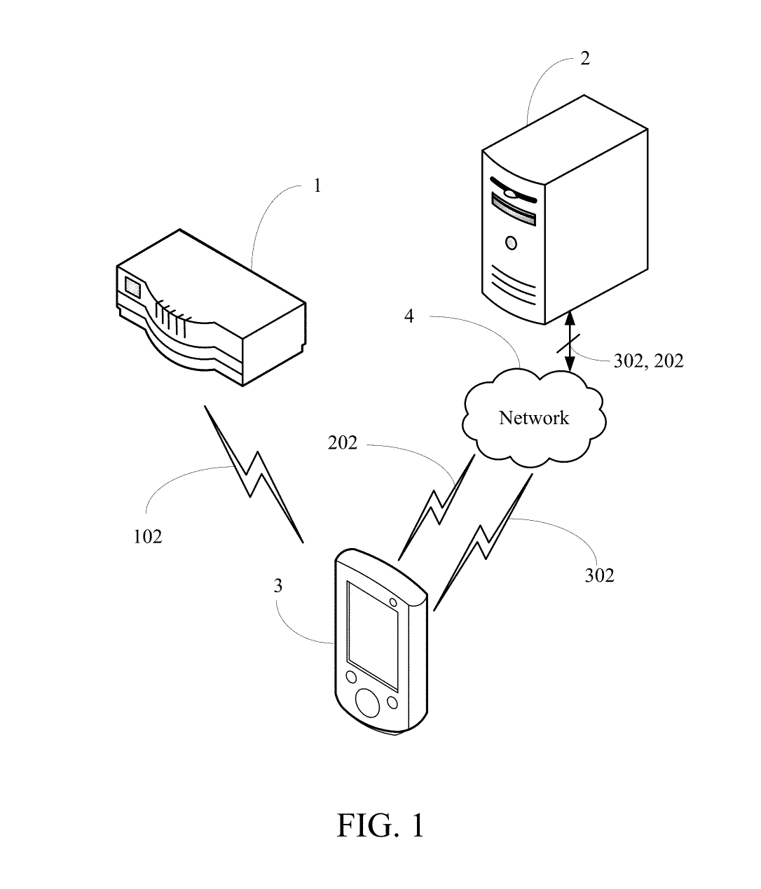

A first embodiment of the present invention is shown in FIG. 1. FIG. 1 depicts an implementation scenario of a wireless device 1, a server 2 and a UE 3 according to the present invention. In this embodiment, the wireless device 1 may be a set top box device, an industrial computer or a personal computer (PC) that can store a plurality of terminal data. Each of the terminal data includes an identification (ID). The wireless device 1 generates a corresponding Bluetooth broadcast signal according to the ID included in each of the terminal data, and transmits the Bluetooth broadcast signals within different time intervals respectively.

The Bluetooth broadcast signal may be an iBeacon signal, an Eddystone signal, an AltBeacon signal or any Bluetooth broadcast signal (e.g., a typical Bluetooth broadcast signal or a low power-consumption Bluetooth broadcast signal) that can be generated without the need of pairing between devices. The Bluetooth broadcast signals carry index data corresponding to different service data. Each of the service data corresponds to one of the terminal data in one-to-one correspondence. The wireless device 1 may use the Bluetooth broadcast signals to carry index data corresponding to the terminal data and the service data by modifying some bytes (e.g., the Major field and the Minor field of the iBeacon signal) of the Bluetooth broadcast signals.

It shall be appreciated that, the index datum in the Bluetooth broadcast signal may be the ID of the terminal datum, i.e., the wireless device 1 may have the ID carried in the Bluetooth broadcast signal directly. Additionally, the index datum in the Bluetooth broadcast signal may be a datum generated by the wireless device 1 through processing the ID (for example but not limited to, encrypting or encoding the ID). Additionally, the ID included in each of the terminal data may be data of various forms (e.g., numerals, English letters or a combination thereof) and may be processed in different manners (for example but not limited to, being encrypted or encoded). In other implementations, the server 2 may also create an index look-up table that stores each ID and its corresponding index datum.

After receiving a current Bluetooth broadcast signal 102 within a time interval, the UE 3 generates a service request message 302 carrying the index datum of the current Bluetooth broadcast signal 102 according to the current Bluetooth broadcast signal 102 and transmits the service request message 302 to the server 2 via a network 4. The network 4 may be a mobile communication network, an Internet, a Local Area Network (LAN) or the like network, or a combination thereof. Then the server 2 receiving the service request message 302 can directly provide the corresponding service data to the UE 3 according to the index datum carried in the service request message 302.

For example, the wireless device 1 may be installed in a restaurant in a food court of a shopping mall. The UE 3 may be a smartphone that connects to the server 2 by executing an application installed in the smartphone and associated with the server 2. The terminal data stored in the wireless device 1 relate to data of different set meals, and the index data of the Bluetooth broadcast signals also correspond to the different set meals respectively. The wireless device 1 transmits different Bluetooth broadcast signals within different time intervals (e.g., every one hour, every thirty minutes and etc.). The service data stored in the server 2 are E-coupons of these set meals. If the index datum of the Bluetooth broadcast signal currently broadcasted by the wireless device 1 corresponds to a set meal A, then the UE 3 receiving the current Bluetooth broadcast signal 102 may transmit the index datum corresponding to the set meal A to the server 2 via the service request message 302. Next, the server 2 transmits an E-coupon corresponding to the set meal A to the UE 3. In this way, the UE 3 can display the E-coupon corresponding to the set meal A in the application to obtain a price discount from the restaurant.

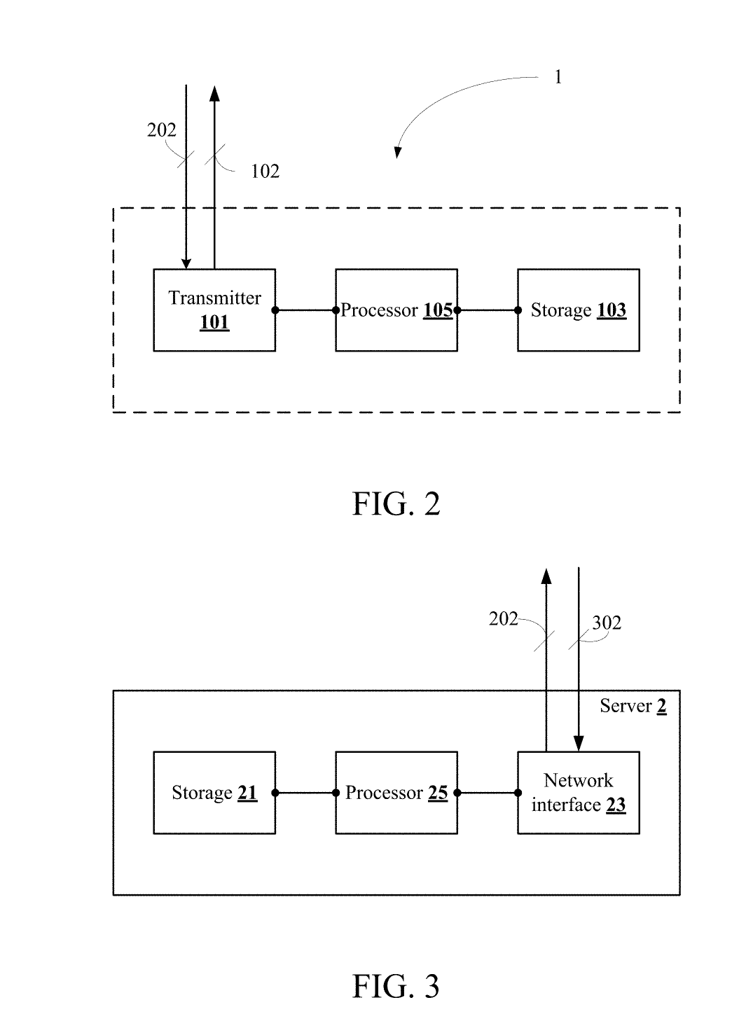

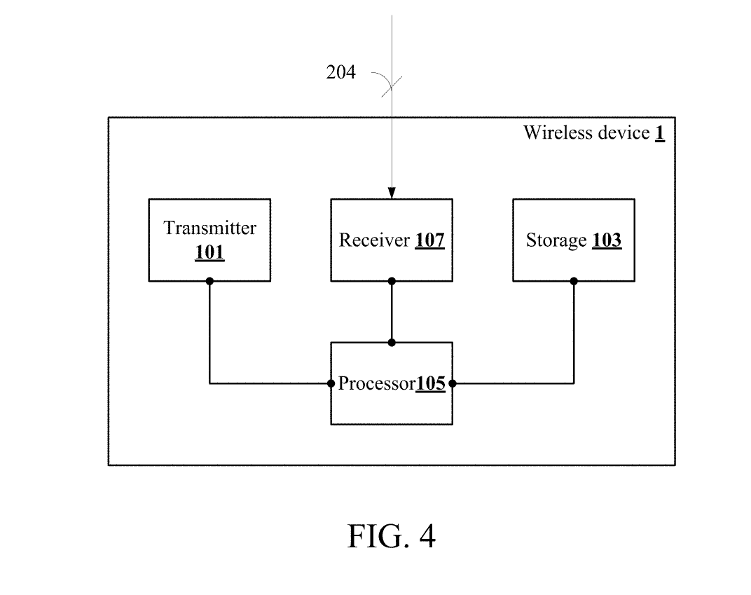

Please refer to FIG. 2 and FIG. 3 for a second embodiment of the present invention. FIG. 2 is a schematic view of the wireless device 1 according to the present invention. The wireless device 1 comprises a transmitter 101, a storage 103 and a processor 105. The transmitter 101 may be a Bluetooth transmitter. The storage 103 may be any storage medium configured to store a plurality of terminal data. Each of the terminal data includes an ID. The processor 105 is electrically connected to the storage 103 and the transmitter 101. The processor 105 generates a Bluetooth broadcast signal according to the ID of each of the terminal data, and transmits the Bluetooth broadcast signals via the transmitter 101 within a plurality of time intervals respectively. The UE 3 that receives a current Bluetooth broadcast signal 102 among the Bluetooth broadcast signals can generate a service request message 302 according to the current Bluetooth broadcast signal 102 and transmit the service request message 302 to the server 2. Then, the UE 3 receives a service data 202 from the server 2. The service data 202 corresponds to the current Bluetooth broadcast signal 102 and is one of a plurality of service data stored in the server 2. The plurality of service data stored in the server 2 correspond in one-to-one correspondence to the terminal data stored in the storage 103.

It shall be appreciated that, in other implementations, it is unnecessary for the transmitter 101, the storage 103 and the processor 105 to be disposed in a single hardware device (e.g., in an enclosure of the wireless device 1), but may be disposed at different positions. For example, the processor 105 may be disposed in the primary enclosure, and the transmitter 101 may be disposed outside the enclosure and connect to the processor 105 either in a wired way or wirelessly so that the transmitter 101 may be disposed at a higher position that is favorable for signal transmission. Therefore, various relative positions of the transmitter 101, the storage 103 and the processor 105 shall all fall within the scope of the present invention.

FIG. 3 is a schematic view of the server 2 according to the present invention. The server 2 comprises a storage 21, a network interface 23 and a processor 25. The storage 21 stores a plurality of service data and a plurality of terminal data. As previously described, the service data correspond to the terminal data in one-to-one correspondence, and each of the terminal data includes an ID. The processor 25 is electrically connected to the storage 21 and the network interface 23. The processor 25 receives the service request message 302 from the UE 3 via the network interface 23 and transmits one of the service data 202 to the UE 3 via the network interface 23 according to the service request message 302.

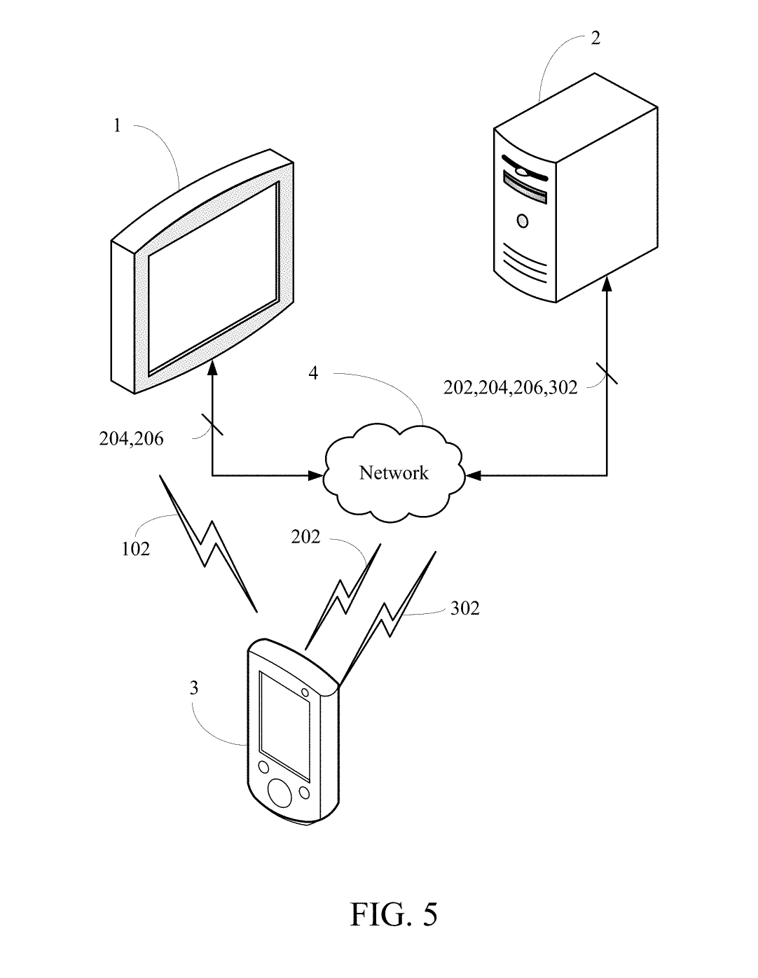

A third embodiment of the present invention is shown in FIG. 4. The third embodiment is an extension of the second embodiment. FIG. 4 is a schematic view of another implementation of the wireless device 1 according to the present invention. The wireless device 1 further comprises a receiver 107 electrically connected to the processor 105. For example, the receiver 107 may be a WIFI receiver, a Bluetooth receiver, a mobile network receiver (i.e., a 3G or 4G mobile network receiver) or the like. In this embodiment, the processor 105 receives a plurality of terminal data 204 from the server 2 via the receiver 107 and stores the terminal data 204 into the storage 103.

It shall be appreciated that, the wireless device 1 may receive the terminal data 204 directly from the server 2 or receive the terminal data 204 from the server 2 via a nearby management device. The management device may be a relay device, a digital signage or a wireless management device (e.g., an industrial computer, a PC, a set top box and etc.) disposed within a signal coverage of a plurality of wireless devices 1. The server 2 may first transmit the terminal data 204 to the nearby management device which then transmits the terminal data 204 to the wireless device 1. In other words, the wireless device 1 may operate in combination with a nearby management device.

As an example, the plurality of wireless devices 1 are installed in a plurality of restaurants in a food court of a shopping mall. The nearby management device may be installed around the restaurants as a bridge between the server 2 and the wireless devices 1. As another example, the nearby management device may also be a digital signage in each restaurants that operate in combination with one or more wireless devices 1 to transmit different Bluetooth broadcast signals carrying index data corresponding to different set meals within different time intervals via the one or more wireless devices 1.

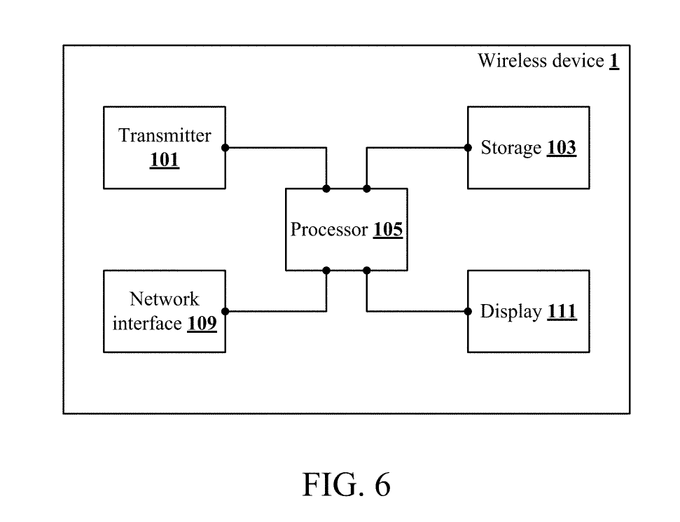

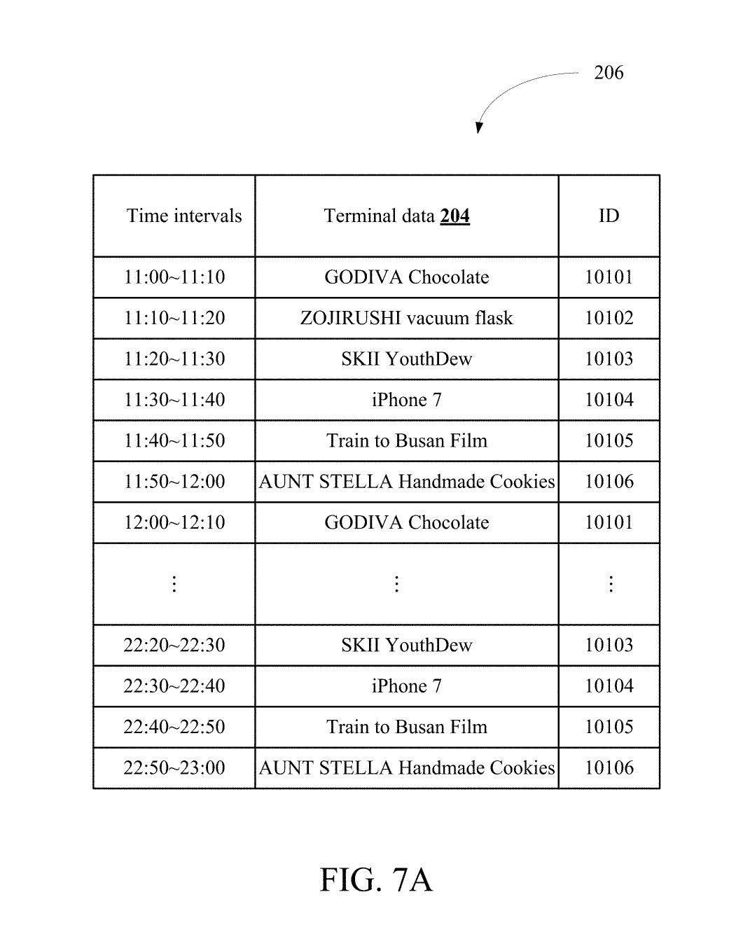

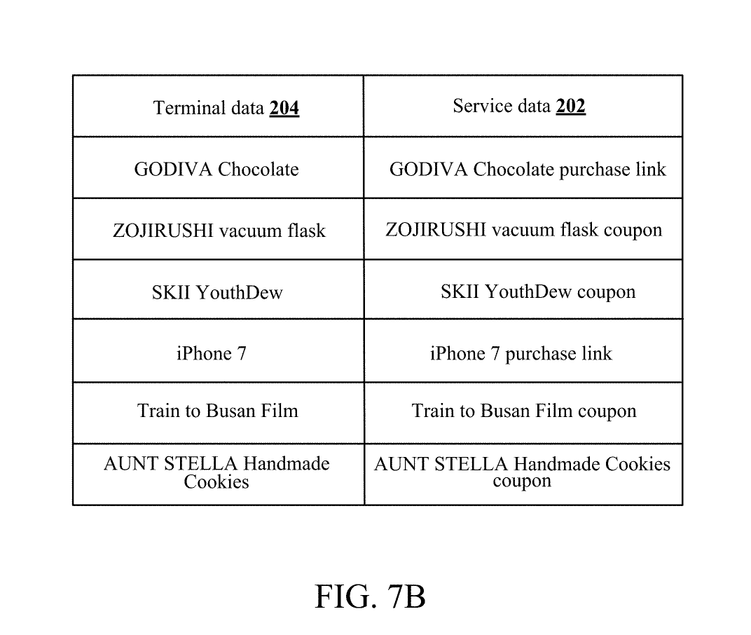

Please refer to FIG. 5, FIG. 6 and FIGS. 7A-7B for a fourth embodiment. The fourth embodiment is also an extension of the second embodiment. FIG. 5 depicts another implementation scenario of the wireless device 1, the server 2 and the UE 3 according to the present invention. FIG. 6 is another schematic view of the wireless device 1 according to the present invention. In this embodiment, the wireless device 1 is a digital signage which further comprises a network interface 109 and a display 111 that are electrically connected to the processor 105. The network interface 109 connects to the network 4. The network interface 109 may be a wired network interface (e.g., an Ethernet interface) or a wireless network interface (e.g., a WIFI network interface, a 3G network interface, a 4G mobile network interface or a combination thereof). The processor 105 receives the terminal data 204 from the server 2 via the network interface 109. Each of the terminal data 204 is a display data.

Similarly, the server 2 stores therein the service data 202 corresponding to the terminal data 204 respectively. Additionally, the processor 105 further receives scheduling information 206 from the server 2 via the network interface 109. The scheduling information 206 defines a correspondence relationship between the time intervals and the terminal data. The processor 105 displays the display data on the display 111 when transmitting the corresponding Bluetooth broadcast signal within a time interval via the transmitter 101.

For example, when the wireless device 1 is a digital signage disposed in a department store, the wireless device 1 connects to the network 4 via the network interface 109 to receive terminal data 204 and scheduling information 206 from the server 2. As shown in FIG. 7A, the terminal data 204 are commodity information or service information in the department store, or are advertisement information of related enterprises. The scheduling information 206 may be used to create a correspondence relationship between time intervals during the business time of the department store and each of the terminal data 204. Additionally, the table data in FIG. 7B also create a correspondence relationship between the terminal data 204 and the service data 202. For example, the terminal data 204 may be advertisement films, alternately played images or prevues related to “GODIVA Chocolate”, “ZOJIRUSHI vacuum flasks”, “SKII YouthDew”, “iPhone 7”, “Train to Busan Film” and “AUNT STELLA Handmade Cookies”, and the corresponding service data 202 may be “GODIVA Chocolate purchase link”, “ZOJIRUSHI vacuum flask coupon”, “SKII YouthDew coupon”, “iPhone 7 purchase link”, “Train to Busan Film coupon” and “AUNT STELLA Handmade Cookies coupon” respectively.

The processor 105 generates a first Bluetooth broadcast signal according to the ID “10101” of “GODIVA Chocolate” within a first time interval (i.e., 11:00˜11:10) to load the index data representing the ID “10101” into the first Bluetooth broadcast signal, transmits the first Bluetooth broadcast signal via the transmitter 101 within the first time interval, and meanwhile, displays the advertisement film or alternately played images of “GODIVA Chocolate” on the display 111. Each ID may be directly used as an index datum corresponding to one of the terminal data 204. In another implementation, an index look-up table may be additionally created to store each of the IDs and the corresponding index data. Then after the first time interval ends, the processor 105 generates a second Bluetooth broadcast signal according to an ID “10102” of “ZOJIRUSHI vacuum flask” within a second time interval (i.e., 11:10˜11:20) to load the index datum representing the ID “10102” into the second Bluetooth broadcast signal, transmits the second Bluetooth broadcast signal via the transmitter 101 within the second time interval, and meanwhile, displays the advertisement film or alternately played images of “ZOJIRUSHI vacuum flask” on the display 111.

After the second time interval ends, the processor 105 generates a third Bluetooth broadcast signal according to an ID “10103” of “SKII YouthDew” within a third time interval (i.e., 11:20˜11:30) to load the index datum representing the ID “10103” into the third Bluetooth broadcast signal, transmits the third Bluetooth broadcast signal via the transmitter 101 within the third time interval, and meanwhile, displays the advertisement film or alternately played images of “SKII YouthDew” on the display 111.

After the third time interval ends, the processor 105 generates a fourth Bluetooth broadcast signal according to an ID “10104” of “iPhone 7” within a fourth time interval (i.e., 11:30˜11:40) to load the index datum representing the ID “10104” into the fourth Bluetooth broadcast signal, transmits the fourth Bluetooth broadcast signal via the transmitter 101 within the fourth time interval, and meanwhile, displays the advertisement film or alternately played images of “iPhone 7” on the display 111.

Likewise, after the fourth time interval ends, the processor 105 generates a fifth Bluetooth broadcast signal according to an ID “10105” of “Train to Busan Film” within a fifth time interval (i.e., 11:40˜11:50) to load the index datum representing the ID “10105” into the fifth Bluetooth broadcast signal, transmits the fifth Bluetooth broadcast signal via the transmitter 101 within the fifth time interval, and meanwhile, displays the advertisement film or alternately played images of “Train to Busan Film” on the display 111.

Then, the processor 105 generates a sixth Bluetooth broadcast signal according to an ID “10106” of “AUNT STELLA Handmade Cookies” within a sixth time interval (i.e., 11:50˜12:00) to load the index datum representing the ID “10106” into the sixth Bluetooth broadcast signal, transmits the sixth Bluetooth broadcast signal via the transmitter 101 within the sixth time interval, and meanwhile, displays the advertisement film or alternately played images of “AUNT STELLA Handmade Cookies” on the display 111.

When a user enters into the department store at 11:45 and comes into the signal coverage of the wireless device 1, the user may execute an application associated with the server 2 via the UE 3 to connect to the server 2, and receive a current Bluetooth broadcast signal 102 (i.e., the fifth Bluetooth broadcast signal). In response to the current Bluetooth broadcast signal 102 received, the application of the UE 3 displays a detected service frame which comprises a “Download” button and a “Cancel” button. If the “Download” button is clicked by the user, then a service request message 302 carrying the index datum of the ID “10105” of the “Train to Busan Film” will be transmitted by the UE 3 to the server 2 according to the current Bluetooth broadcast signal 102. Upon receiving the service request message 302, the server 2 searches in all the service data 202 stored therein according to the index datum representing the ID “10105 and finds that the service data corresponding to the index datum representing the ID “10105” is the “Train to Busan Film coupon”, and transmits the “Train to Busan Film coupon” back to the UE 3. In this way, the user can obtain a price discount of the film ticket by displaying the “Train to Busan Film coupon” on the UE 3.

In other embodiments, the UE 3 may first download a plurality of preloaded data 208 from the server 2 when the UE 3 is executing the application associated with the server 2 to connect to the server 2. As shown in FIG. 7C, there is a one-to-one correspondence relationship between the service data 202, the terminal data 204 and the preloaded data 208. In such implementations, the preloaded data 208 are “GODIVA Chocolate purchase link”, “ZOJIRUSHI vacuum flask coupon”, “SKII YouthDew coupon”, “iPhone 7 purchase link”, “Train to Busan Film coupon” and “Aunt STELLA Handmade Cookies coupon”, and the service data 202 are “code corresponding to GODIVA Chocolate”, “code corresponding to ZOJIRUSHI vacuum flask”, “code corresponding to SKII YouthDew”, “code corresponding to iPhone 7”, “code corresponding to Train to Busan” and “code corresponding to AUNT STELLA Handmade Cookies”.

Accordingly, a current Bluetooth broadcast signal 102 (e.g., the fifth Bluetooth broadcast signal) is received by the UE 3. Then in response to the current Bluetooth broadcast signal 102, the UE 3 transmits a service request message 302 carrying the index datum corresponding to the ID “10105” of the “Train to Busan Film data” to the server 2. Upon receiving the service request message 302, the server 2 searches in all the service data 202 stored therein according to the index datum representing the ID “10105” and finds that the service data corresponding to the index datum representing the ID “10105” is the “code corresponding to Train to Busan Film”, and transmits the “code corresponding to Train to Busan Film” back to the UE 3. After the “code corresponding to Train to Busan Film” is received by the UE 3, the application compares the “code corresponding to Train to Busan Film” with the preloaded data 208 stored and displays a detected service frame which comprises an “Activate” button and a “Cancel” button. If the “Activate” button is clicked by the user, a “Train to Busan Film coupon” will be displayed on the UE 3.

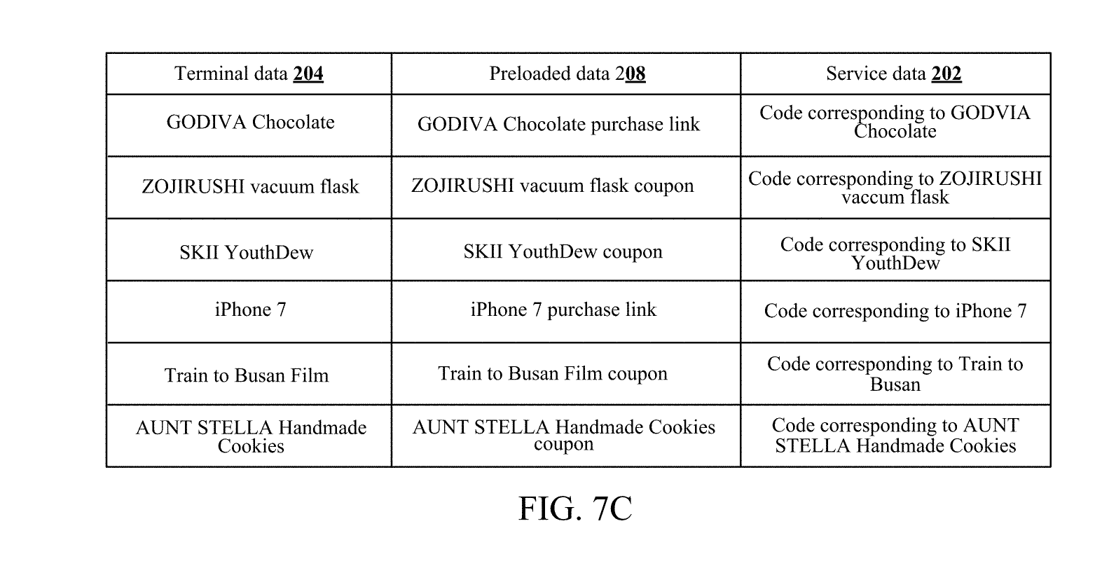

A fifth embodiment of the present invention is shown in FIG. 8. The fifth embodiment is also an extension of the second embodiment. FIG. 8 depicts another implementation scenario of the wireless device 1, the server 2 and the UE 3 according to the present invention. In this embodiment, the terminal datum 104 is a user datum, e.g., a picture, a music file, a document file or the like. The wireless device 1 connects to the network 4, uploads at least one terminal datum stored therein to the server 2 via the network 4, and generates a Bluetooth broadcast signal according to an ID of the terminal datum 104 so that an index datum representing the terminal datum 104 is carried in the Bluetooth broadcast signal.

The server 2 receiving the terminal datum 104 may directly store the terminal datum 104 as a service data 202 or generates a service data 202 according to the terminal datum 104. After receiving a current Bluetooth broadcast signal 102 among the Bluetooth broadcast signals transmitted by the wireless device 1, the UE 3 transmits the service request message 302 to the server 2 according to the current Bluetooth broadcast signal 102. The server 2 receiving the service request message 302 directly provides the service data 202 to the UE 3 according to the index datum.

As an example, the wireless device 1 may be a UE, e.g., a smartphone, a tablet computer or the like. When the user of the wireless device 1 is to transmit a picture (i.e., the terminal datum 104) to the user of the UE 3, the user of the wireless device 1 may operate the wireless device 1 to upload the picture to the server 2 via the network 4 and, meanwhile, to generate a current Bluetooth broadcast signal 102 according to an ID “854632” of the picture (e.g., load the ID “854632” of the picture into the current Bluetooth broadcast signal 102 as the index datum corresponding to the picture). Then the server 2 receiving the picture stores the picture uploaded by the wireless device 1 as a service data 202. Upon receiving the Bluetooth broadcast signal 102 transmitted by the wireless device 1, the UE 3 can transmit the service request message 302 carrying the ID “854632” to the server 2 according to the current Bluetooth broadcast signal 102 so that the server 2 can directly provide the picture (i.e., the service data 202 corresponding to the ID “854632”) to the UE 3 according to the ID “854632”.

As another example, the wireless device 1 may be an interaction service platform, e.g., a picture editing platform, a ticket booking platform or the like. The user may operate the wireless device 1 to generate a terminal datum 104 (e.g., a ticket booking datum) and upload the terminal datum 104 to the server 2. Meanwhile, a current Bluetooth broadcast signal 102 is generated by the wireless device 1 according to an ID of the ticket booking datum (e.g., loading the ID of the ticket booking datum into the current Bluetooth broadcast signal 102 as an index datum corresponding to the ticket booking datum). Subsequently, an E-ticket may be generated by the server 2 after receiving the ticket booking datum. Then, the user may operate the UE 3 to receive the current Bluetooth broadcast signal 102 and transmit the service request message 302 carrying the ID of the ticket booking datum to the server 2 according to the current Bluetooth broadcast signal 102 so that the server 2 can directly provide the E-ticket to the UE 3 according to ID of the ticket booking datum.

It shall be appreciated that, only a single UE 3 is described in the above embodiments for purpose of simplicity. However, as will be readily appreciated by those of ordinary skill in the art, the wireless device 1 and the server 2 of the present invention may interact with a plurality of UEs simultaneously to provide index data and service data to the UEs, so the number of UEs is not intended to limit the scope of the present invention. Additionally, an additional authentication mechanism may be provided for interactions between the UE 3 and the server 2 according to the present invention. For example, the user of the UE 3 may be required to input a password that has been set in advance in the wireless device 1 when the E-ticket received from the server 2 is to be opened.

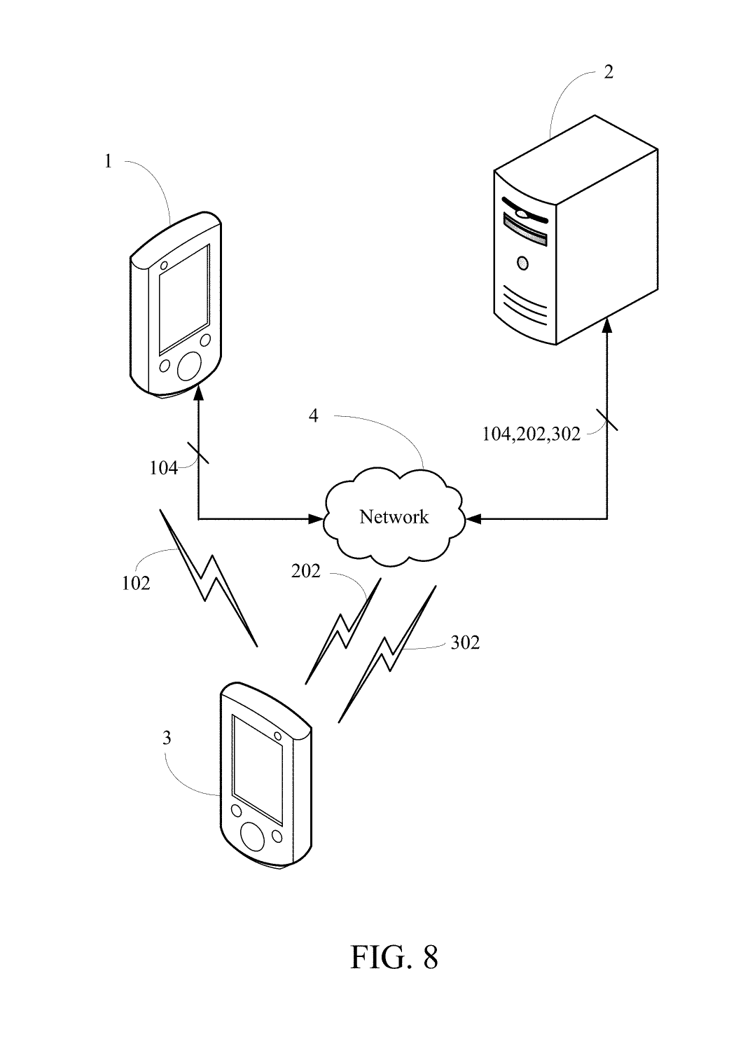

A sixth embodiment of the present invention is shown in FIG. 9. FIG. 9 is a schematic view of a wireless transmission system 5 according to the present invention. The wireless transmission system 5 comprises a Bluetooth device 51 and a management device 53. The management device 53 stores a plurality of terminal data. Each of the terminal data includes an ID. The management device 53 generates a control signal 532 according to the ID of each of the terminal data and transmits the control signals 532 to the Bluetooth device 51 at a plurality of time points respectively. Each of the control signals 532 carries an index datum of the corresponding terminal datum. As previously described, the ID of each of the terminal data may be directly used as an index datum.

The Bluetooth device 51 stores a Bluetooth datum and continuously generate and transmit Bluetooth broadcast signals according to the Bluetooth data. The Bluetooth datum corresponds to some bytes of each of the Bluetooth broadcast signals (e.g., the Major field and the Minor field in the iBeacon signal). The Bluetooth device 51 receiving a control signal modifies the Bluetooth datum according to an index datum in the control signal. Thus, pieces of information carried in the Bluetooth broadcast signals transmitted by the Bluetooth device 51 within the time intervals of the time points are different from each other. Thereby, when a current Bluetooth broadcast signal 102 among the Bluetooth broadcast signals is received by a UE, the UE can transmit a service request message 302 to the server 2 according to the current Bluetooth broadcast signal 102 and receive a service data 202, which corresponds to the current Bluetooth broadcast signal 102, among a plurality of service data stored in the server 2.

For example, the management device 53 may be installed at a central position of a food court of a shopping mall, connect to the server in a wired way, and manage one or more Bluetooth devices (e.g., the Bluetooth device 51) in a wireless way. The Bluetooth device 51 may be disposed on the ceiling of a restaurant. The UE 3 may be a smartphone that connects to the server 2 by executing an application installed in the smartphone and associated with the server 2. The terminal data stored in the management device 53 relate to data of different set meals. The service data stored in the server 2 are E-coupons of the different set meals.

The management device 53 generates control signals 532 carrying IDs of the terminal data according to the IDs at different time points (e.g., every one hour, every thirty minutes and etc.), and transmits the control signals 532 to the Bluetooth device 51 in a wireless way (e.g., through Bluetooth, WIFI and etc.). Then the Bluetooth device 51 modifies the Bluetooth data stored therein according to the ID carried in the control signals 532, and then generates Bluetooth broadcast signals carrying the IDs according to the Bluetooth data.

In this exemplary example, the management device 53 may transmit a control signal 532 carrying the ID of the set meal A to the Bluetooth device 51 at AM 11:00. Then the Bluetooth device 51 modifies the stored Bluetooth datum according to the ID of the set meal A, and generates a current Bluetooth broadcast signal 102 carrying the ID of the set meal A according to the modified Bluetooth datum. Thus, the UE 3 receiving the current Bluetooth broadcast signal 102 can transmit the ID corresponding to the set meal A to the server 2 via the service request message 302. Next, the server 2 transmits the E-coupon corresponding to the set meal A to the UE 3. In this way, the UE 3 can display the E-coupon corresponding to the set meal A in the application to obtain a price discount from the restaurant.

Likewise, when the management device 53 needs to modify the Bluetooth data stored in the Bluetooth device 51 so that Bluetooth broadcast signals broadcasted by the Bluetooth device 51 carry IDs of different set meals, the management device 53 generates and transmits control signals 532 to the Bluetooth device 51. For example, the management device 53 may transmit a control signal 532 carrying the ID of the set meal B to the Bluetooth device 51 at PM 12:00, transmit a control signal 532 carrying the ID of the set meal C to the Bluetooth device 51 at PM 1:00, and so on. In this case, the Bluetooth device 51 broadcasts the Bluetooth broadcast signal carrying the ID of the set meal A between AM 11:00˜PM 12:00, broadcasts the Bluetooth broadcast signal carrying the ID of the set meal B between PM 12:00˜PM 1:00, and broadcasts the Bluetooth broadcast signal carrying the ID of the set meal C between PM 1:00˜PM 2:00.

It shall be appreciated that, although the aforesaid exemplary example only describes how the management device 53 transmits control signals to modify the Bluetooth data stored in the Bluetooth device 51 so that different Bluetooth broadcast signals are broadcasted to represent different service information, the management device 53 of the present invention may also manage a plurality of Bluetooth devices and transmit control signals to the plurality of Bluetooth devices to modify the Bluetooth data stored therein. Because how the management device 53 manages the plurality of Bluetooth devices can be readily appreciated by those of ordinary skill in the art, it will not be further described herein.

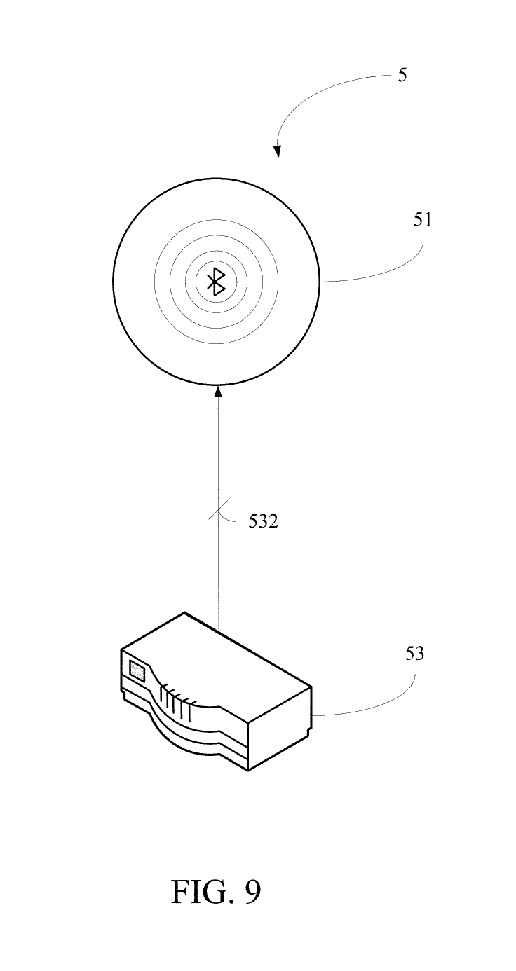

A seventh embodiment of the present invention is an index data providing method, a flowchart diagram of which is shown in FIG. 10. The index data providing method is suitable for a wireless device (e.g., the aforesaid wireless device 1). The wireless device comprises a transmitter, a storage and a processor. The storage stores a plurality of terminal data. Each of the terminal data includes an ID. The index data providing method is executed by the processor.

First in step S1001, a Bluetooth broadcast signal is generated according to the ID of each of the terminal data. Then in step S1003, the Bluetooth broadcast signals are transmitted via the transmitter within a plurality of time intervals respectively. Accordingly, after a UE receives a current Bluetooth broadcast signal among the Bluetooth broadcast signals, it can transmit a service request message to a server according to the current Bluetooth broadcast signal and consequently receive a service data, which corresponds to the current Bluetooth broadcast signal and is one of a plurality of service data stored in the server, from the server. The plurality of service data correspond to the terminal data in one-to-one correspondence.

In other embodiments, the wireless device further comprises a network interface electrically connected to the processor. The network interface connects to a network, and the index data providing method further comprises the following step of: receiving the plurality of terminal data from the server via the network interface. Further in an embodiment, the index data providing method further comprises the following step of: transmitting the terminal data to the server via the network interface.

In other embodiments, the wireless device may further comprise a display electrically connected to the processor, and each of the terminal data is a display data, and the index data providing method further comprises the following steps of: receiving scheduling information from the server via the network interface, the scheduling information defines a correspondence relationship between the time intervals and the terminal data; and displaying the corresponding display data on the display according to the scheduling information when the corresponding Bluetooth broadcast signal is transmitted by the transmitter within each of the time intervals.

In other embodiments, the wireless device further comprises a receiver electrically connected to the processor, and the index data providing method further comprises the following step of: receiving the terminal data from a nearby management device via the receiver. The nearby management device receives the terminal data from a server.

In addition to the aforesaid steps, the index data providing method of the present invention can also execute all operations described in the all the aforesaid embodiments and have all the corresponding functions, and because how this embodiment executes these operations and have these functions can be readily understood by those of ordinary skill in the art, this will not be further described herein.

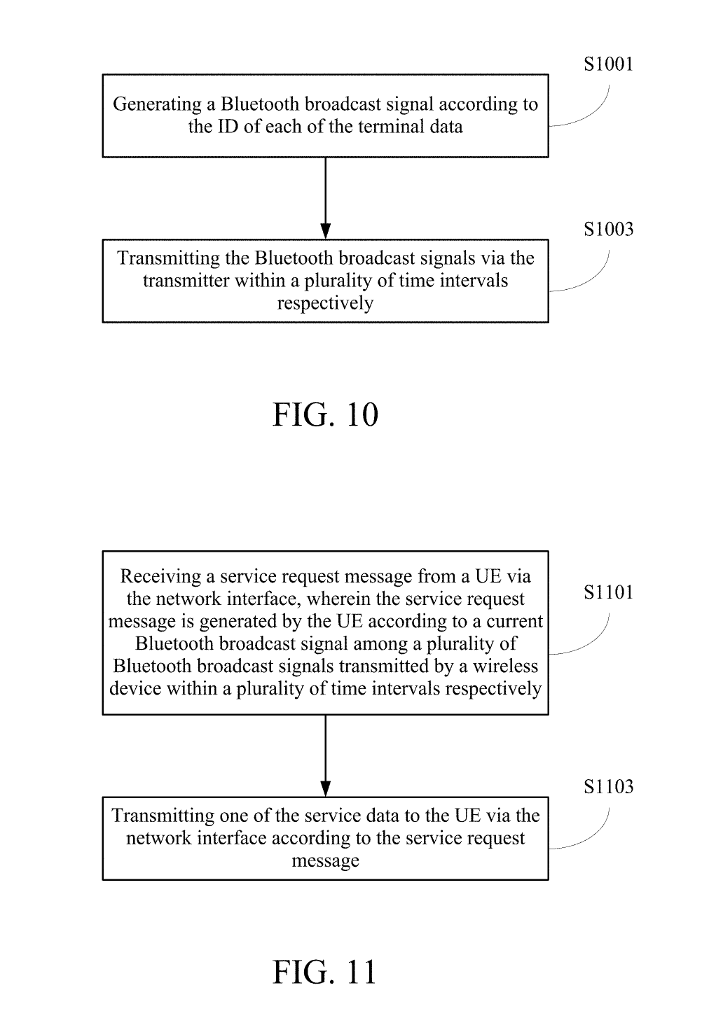

An eighth embodiment of the present invention is a data providing method, a flowchart diagram of which is shown in FIG. 11. The data providing method is suitable for a server (e.g., the server 2 of the aforesaid embodiments). The server comprises a storage, a network interface and a processor. The storage stores a plurality of service data and a plurality of terminal data. The service data correspond to the terminal data in one-to-one correspondence, and each of the terminal data includes an ID. The processor is electrically connected to the storage and the network interface. The data providing method is executed by the processor.

First in step S1101, a service request message is received from a UE via the network interface. The service request message is generated by the UE according to a current Bluetooth broadcast signal among a plurality of Bluetooth broadcast signals transmitted by a wireless device within a plurality of time intervals respectively. The wireless device stores the plurality of terminal data and generates a corresponding Bluetooth broadcast signal according to the ID of each of the terminal data. Next in step S1103, one of the service data is transmitted to the UE via the network interface according to the service request message.

In other embodiments, the data providing method further comprises the following step of: transmitting the terminal data to the wireless device via the network interface. Further in an embodiment, each of the terminal data is a display data, and the data providing method further comprises the following step of: transmitting scheduling information to the wireless device via the network interface, wherein the scheduling information defines a correspondence relationship between the time intervals and the terminal data so that the wireless device displays the corresponding display data on a display according to the scheduling information when the corresponding Bluetooth broadcast signal is transmitted within each of the time intervals. In other embodiments, the data providing method further comprises the following step of: receiving the terminal data from the wireless device via the network interface.

In addition to the aforesaid steps, the data providing method of the present invention can also execute all operations described in the all the aforesaid embodiments and have all the corresponding functions, and because how this embodiment executes these operations and have these functions can be readily understood by those of ordinary skill in the art, this will not be further described herein.

According to the above descriptions, the present invention provides a real-time data providing mechanism by transmitting Bluetooth broadcast signals carrying different index data within different time intervals, and this simplifies the procedure that needs to be performed by the server so that the server can provide service data needed by the user in real time.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

1. A wireless device, comprising:
a transmitter;
a storage, being configured to store a plurality of terminal data, each of the terminal data including an identification (ID); and
a processor electrically connected to the storage and the transmitter, being configured to generate a plurality of different Bluetooth broadcast signals, each of which carries different service information, according to the IDs of the terminal data, respectively, and transmit the different Bluetooth broadcast signals via the transmitter within a plurality of time intervals respectively so that a user equipment (UE) receiving a current Bluetooth broadcast signal among the Bluetooth broadcast signals transmits a service request message to a server according to the current Bluetooth broadcast signal and receives a service data, which corresponds to the current Bluetooth broadcast signal and is one of a plurality of service data stored in the server, from the server;
wherein the plurality of service data correspond to the terminal data in one-to-one correspondence.

2. The wireless device of claim 1, further comprising a network interface electrically connected to the processor, wherein the network interface connects to a network, and the processor receives the terminal data from the server via the network interface.

3. The wireless device of claim 2, further comprising a display electrically connected to the processor, wherein each of the terminal data is a display data, the processor further receives scheduling information from the server via the network interface, the scheduling information defines a correspondence relationship between the time intervals and the terminal data, and the processor is further configured to display the corresponding display data on the display according to the scheduling information when the corresponding Bluetooth broadcast signal is transmitted by the transmitter within each of the time intervals.

4. The wireless device of claim 1, further comprising a network interface electrically connected to the processor, wherein each of the terminal data is a user datum, the network interface connects to a network, and the processor transmits the terminal data to the server via the network interface.

5. The wireless device of claim 1, further comprising a receiver electrically connected to the processor, wherein the processor receives the terminal data from a nearby management device via the receiver, and the nearby management device receives the terminal data from a server.

6. A server, comprising:
a storage, being configured to store a plurality of service data and a plurality of terminal data, the service data corresponding to the terminal data in one-to-one correspondence, each of the terminal data including an ID;
a network interface; and
a processor electrically connected to the storage and the network interface, being configured to receive a service request message from a UE via the network interface and transmit one of the service data to the UE via the network interface according to the service request message;
wherein the UE receives a current Bluetooth broadcast signal among a plurality of different Bluetooth broadcast signals, each of which carries different service information, transmitted by a wireless device within a plurality of time intervals respectively and generates the service request message according to the current Bluetooth broadcast signal, and the wireless device stores the terminal data and generates the corresponding Bluetooth broadcast signal according to the ID of each of the terminal data.

7. The server of claim 6, wherein the processor further transmits the terminal data to the wireless device via the network interface.

8. The server of claim 7, wherein each of the terminal data is a display data, the processor further transmits scheduling information to the wireless device via the network interface, the scheduling information defines a correspondence relationship between the time intervals and the terminal data so that the wireless device displays the corresponding display data on a display according to the scheduling information when the corresponding Bluetooth broadcast signal is transmitted within each of the time intervals.

9. The server of claim 6, wherein the processor further receives the terminal data from the wireless device via the network interface.

10. An index data providing method for a wireless device, the wireless device comprising a transmitter, a storage and a processor, the storage storing a plurality of terminal data, each of the terminal data including an ID, and the index data providing method being executed by the processor and comprising:
generating a plurality of different Bluetooth broadcast signals, each of which carries different service information, according to the IDs of the terminal data, respectively; and
transmitting the different Bluetooth broadcast signals via the transmitter within a plurality of time intervals respectively;
wherein a UE receiving a current Bluetooth broadcast signal among the Bluetooth broadcast signals transmits a service request message to a server according to the current Bluetooth broadcast signal and receives a service data, which corresponds to the current Bluetooth broadcast signal and is one of a plurality of service data stored in the server, from the server, and the plurality of service data correspond to the terminal data in one-to-one correspondence.

11. The index data providing method of claim 10, wherein the wireless device further comprises a network interface electrically connected to the processor, wherein the network interface connects to a network, the index data providing method further comprising:
receiving the terminal data from the server via the network interface.

12. The index data providing method of claim 11, wherein the wireless device further comprises a display electrically connected to the processor, and each of the terminal data is a display data, the index data providing method further comprising:
receiving scheduling information from the server via the network interface, the scheduling information defines a correspondence relationship between the time intervals and the terminal data; and
displaying the corresponding display data on the display according to the scheduling information when the corresponding Bluetooth broadcast signal is transmitted by the transmitter within each of the time intervals.

13. The index data providing method of claim 10, wherein the wireless device further comprises a network interface electrically connected to the processor, each of the terminal data is a user datum, and the network interface connects to a network, the index data providing method further comprising:
transmitting the terminal data to the server via the network interface.

14. The index data providing method of claim 10, wherein the wireless device further comprises a receiver electrically connected to the processor, the index data providing method further comprising:
receiving the terminal data from a nearby management device via the receiver;
wherein the nearby management device receives the terminal data from a server.

15. A data providing method for a server, the server comprising a storage, a network interface and a processor, the storage storing a plurality of service data and a plurality of terminal data, the service data corresponding to the terminal data in one-to-one correspondence, each of the terminal data including an ID, and the processor being electrically connected to the storage and the network interface, the data providing method being executed by the processor and comprising:
receiving a service request message from a UE via the network interface; and
transmitting one of the service data to the UE via the network interface according to the service request message;
wherein the UE receives a current Bluetooth broadcast signal among a plurality of different Bluetooth broadcast signals, each of which carries different service information, transmitted by a wireless device within a plurality of time intervals respectively and generates the service request message according to the current Bluetooth broadcast signal, and the wireless device stores the terminal data and generates the corresponding Bluetooth broadcast signal according to the ID of each of the terminal data.

16. The data providing method of claim 15, wherein the data providing method further comprises:
transmitting the terminal data to the wireless device via the network interface.

17. The data providing method of claim 16, wherein each of the terminal data is a display data, the data providing method further comprising:
transmitting scheduling information to the wireless device via the network interface, the scheduling information defining a correspondence relationship between the time intervals and the terminal data so that the wireless device displays the corresponding display data on a display according to the scheduling information when the corresponding Bluetooth broadcast signal is transmitted within each of the time intervals.

18. The data providing method of claim 15, wherein the data providing method further comprises:
receiving the terminal data from the wireless device via the network interface.

19. A wireless transmission system, comprising:
a Bluetooth device, storing a Bluetooth datum; and
a management device, storing a plurality of terminal data, each of the terminal data including an ID, and the management device generating a control signal with an index datum according to the ID of each of the terminal data and transmitting the control signals to the Bluetooth device at a plurality of time points respectively;
wherein after receiving the control signal transmitted by the management device at each of the time points, the Bluetooth device modifies the Bluetooth datum according to the index datum in the control signal, generates a Bluetooth broadcast signal based on the modified Bluetooth datum within a plurality of time intervals of the time points respectively and transmits the Bluetooth broadcast signal so that a UE receiving a current Bluetooth broadcast signal among the different Bluetooth broadcast signals, each of which carries different service information, transmits a service request message to a server according to the current Bluetooth broadcast signal and receives a service data, which corresponds to the current Bluetooth broadcast signal and is one of a plurality of service data stored in the server, from the server;
wherein the plurality of service data correspond to the terminal data in one-to-one correspondence.
